(19) United States
(12) Patent Application Publication
(10) Pub. No.: US 2014/0355583 A1
(43) Pub. Date: Dec. 4, 2014

(54) WIRELESS COMMUNICATING METHOD AND ELECTRONIC SYSTEM UTILIZING THE WIRELESS COMMUNICATING METHOD

(71) Applicant: Mediatek Inc., Hsin-Chu (TW)

(72) Inventors: Ching-Lan Wang, Hsinchu City (TW); Shao-Wei Chen, New Taipei City (TW); Shun-Yong Huang, Taipei City (TW)

(73) Assignee: MEDIATEK INC., Hsin-Chu (TW)

(21) Appl. No.: 14/024,611

(22) Filed: Sep. 11, 2013

Related U.S. Application Data
(60) Provisional application No. 61/827,766, filed on May 28, 2013.

(51) Int. Cl. H04W 4/08; H04W 12/04

(52) U.S. Cl. CPC H04W 4/08; H04W 12/04
USPC 370/338

(57) ABSTRACT

A wireless communicating method for building direct communication between a first electronic device and a second electronic device. The wireless communicating method comprises: (a) controlling the first electronic device and the second electronic device to exchange communicating information of each other, wherein the communicating information comprises first password information, and comprises at least one of first IP information and first service information; and (b) after the step (a), confirming the first password information.

### CROSS REFERENCE TO RELATED APPLICATIONS

This application claims the benefit of U.S. Provisional Application No. 61/827,766 filed on May 28, 2013 and entitled “Method for building Wi-Fi direct fast connection in the network”, the contents of which are incorporated herein by reference.

### BACKGROUND

Wi-Fi Direct is a communication technique which allows electronic devices to directly connect each other for data exchange without an Access Point (AP) beyond a conventional wireless LAN technique in which networking is made based on an AP.

FIG. 1 is a schematic diagram illustrating two electronic devices utilizing a Wi-Fi Direct connection for related art. Referring to FIG. 1, a basic Wi-Fi Direct connection scheme performs a one-to-one connection between a first electronic 1 device E₁ and a second electronic device E₂, thus forming a Wi-Fi Direct network WD. The pair of the first electronic device E₁ and the second electronic device E₂ may be, for example, two smart phones, a notebook and a mouse, and a tablet Personal Computer (PC) and a printer, etc. The first electronic device E₁ and the second electronic device E₂ are directly connected to each other through Wi-Fi Direct, thus establishing an Internet connection or forming a network. In addition, an electronic device may form a network with one or more electronic devices in the vicinity of the electronic device, such as a digital camera, a Motion Picture Experts' Group Audio Layer 3 (MP3) player, a game console, a TV, etc. Consequently, various forms of communications and transfers are enabled. For example, a picture, a music file, or a moving image contained in a smart phone may be easily transmitted to another smart phone, a document and a picture stored in a tablet PC may be directly printed, contact information of a PC and contact information of a smart phone may be synchronized with each other, and game consoles may be directly connected to be used for playing a game.

FIG. 2 is a flow chart illustrating the steps for building a Wi-Fi Direct connection between a first electronic device and a second electronic device for related art. The flowchart in FIG. 2 comprises the following steps:

Step 201

Search electronic devices. For example, a user utilizes the first electronic device E₁ to search if any electronic device supporting Wi-Fi Direct thereof in the vicinity thereof, and the second electronic device E₂ is found.

Step 203

The first electronic device E₁ and the second electronic device E₂ exchange ability and configuration method information, which indicates the service that the first electronic device E₁ and the second electronic device E₂ can provide.

Step 205

Performs GO (group owner) negotiation. Such step determines which one of the first electronic device E₁ and the second electronic device E₂ is GO and which one is GC (group client). Many mechanism can be utilized to determine GO, for example, MAC address comparison or intent comparison.

Step 207

Set GO, GC according to the negotiation result in the step 205.

Step 209

Exchange password information (ex. WPS exchange).

Step 211

Confirm password information (ex. 4-way handshake).

Step 213

Exchange IP information. (ex. DHCP).

Step 215

Exchange service information, which indicates the service desired to be performed.

In view above-mentioned description, various exchange steps are needed for building a WiFi-Direct connection for related art, thus building a Wi-Fi Direct connection takes much time.

### SUMMARY

Therefore, one objective of the present application is to provide a wireless communicating method that can reduce the necessary time for building a direct communication between two electronic devices.

Another objective of the present application is to provide an electronic system that can reduce the necessary time for building a direct communication between two electronic devices.

One embodiment of the present application provides a wireless communicating method, for building direct communication between a first electronic device and a second electronic device. The wireless communicating method comprises: (a) controlling the first electronic device and the second electronic device to exchange communicating information of each other, wherein the communicating information comprises first password information, and comprises at least one of first IP information and first service information; and (b) after the step (a), confirming the first password information.

One embodiment of the present application provides an electronic system, which comprises: a first electronic device; a second electronic device; and a control module, for building direct communication between the first electronic device and the second electronic device. The control module controls the first electronic device and the second electronic device to exchange communicating information of each other. The communicating information comprises first password information, and comprises at least one of first IP information and first service information. After the communicating information is exchanged, the control module confirms the first password information.

In view of above-mentioned embodiments, the necessary time for building a direct communication between two electronic devices can be decreased via reducing the number of information exchanging steps. Also, transmitting all communication information via a single packet or one time exchanging can further reduce the necessary time for building the direct communication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating two electronic devices utilizing Wi-Fi Direct for related art.

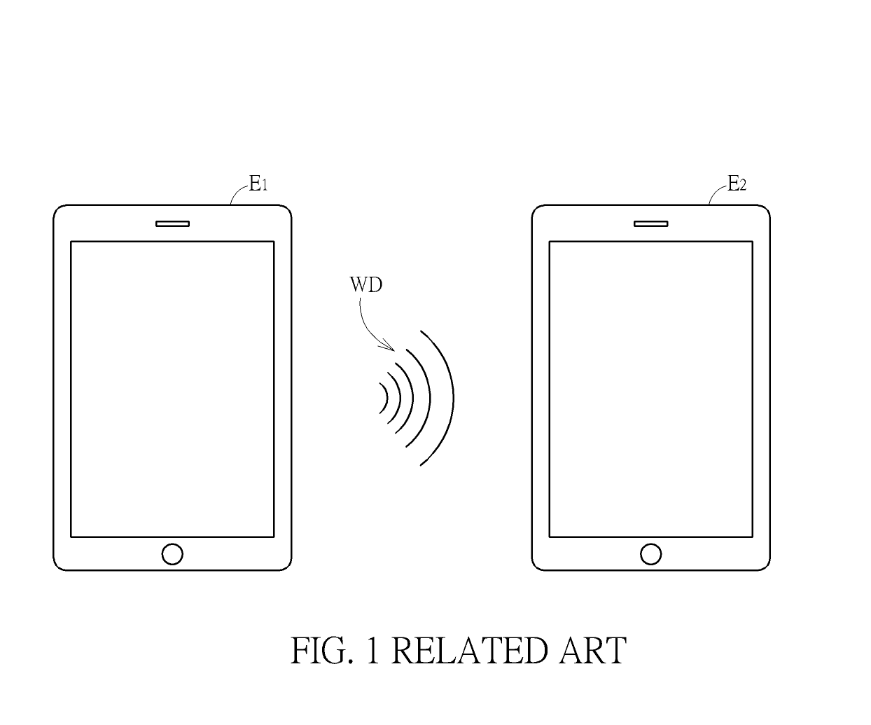

FIG. 2 is a flow chart illustrating the steps for building a Wi-Fi Direct connection between a first electronic device and a second electronic device for related art.

FIG. 3 is a flow chart illustrating the steps for a wireless communicating method according to one embodiment of the present application.

FIG. 4 is a flow chart illustrating the steps for a wireless communicating method according to another embodiment of the present application.

FIG. 5 is a schematic diagram illustrating a packet comprising the communicating information in FIG. 3 and FIG. 4.

FIG. 6 is a schematic diagram illustrating an electronic system utilizing the wireless communicating methods in FIG. 3 and FIG. 4.

### DETAILED DESCRIPTION

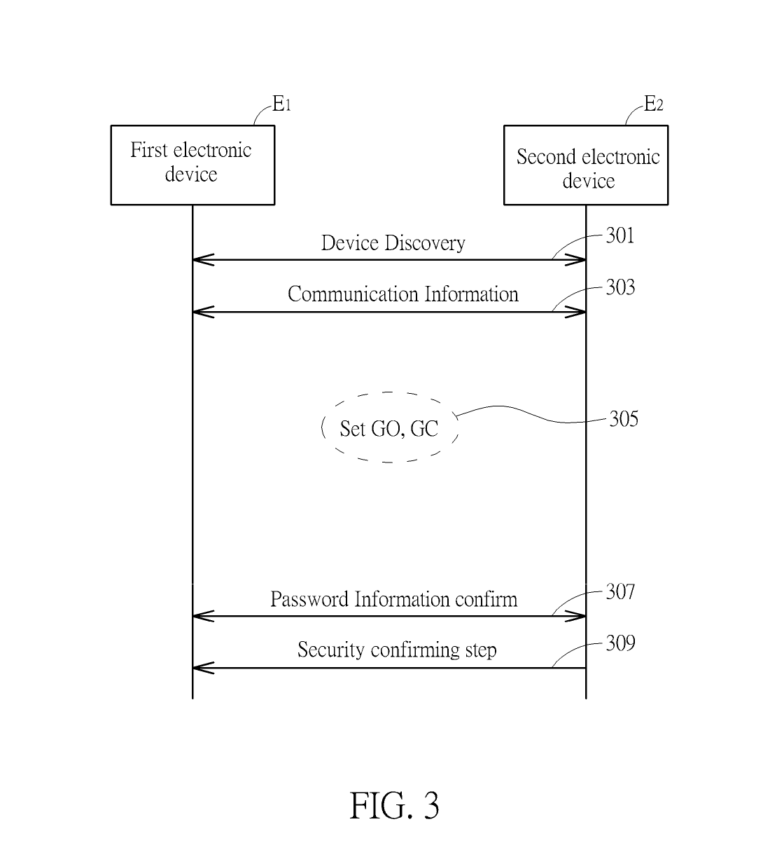

FIG. 3 is a flow chart illustrating the steps for a wireless communicating method according to one embodiment of the present application. Please note it is not limited that all the steps in FIG. 3 must be included. The wireless communicating method is for building direct communication between a first electronic device and a second electronic device. The direct communication can follow the above-mentioned Wi-Fi Direct standard, but can follow other wireless communicating standards as well.

The flow chart in FIG. 3 comprises:

Step 301

Search electronic devices. For example, a user utilizes the first electronic device E₁ to search if any electronic device supporting Wi-Fi Direct thereof in the vicinity thereof, and the second electronic device E₂ is found.

Step 303

Control the first electronic device and the second electronic device to exchange communicating information of each other.

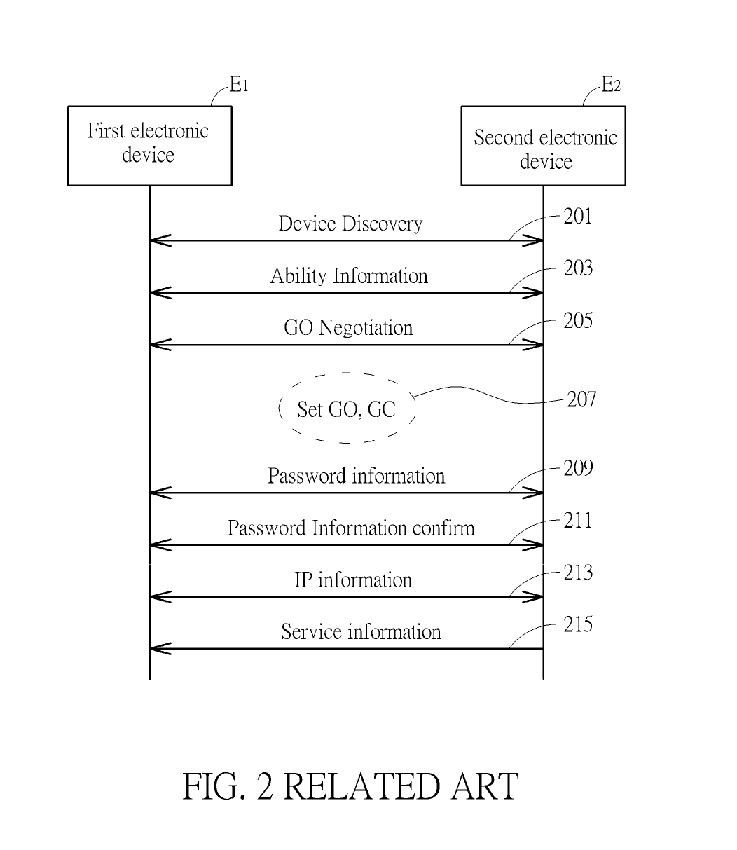

The communicating information comprises password information (i.e. the information for the step 209 in FIG. 2), and comprises at least one of IP information (i.e. the information for the step 213 in FIG. 2) and service information (i.e. the information for the step 215 in FIG. 2).

Step 307

After the step 303, confirm the password information exchanged in the step 303.

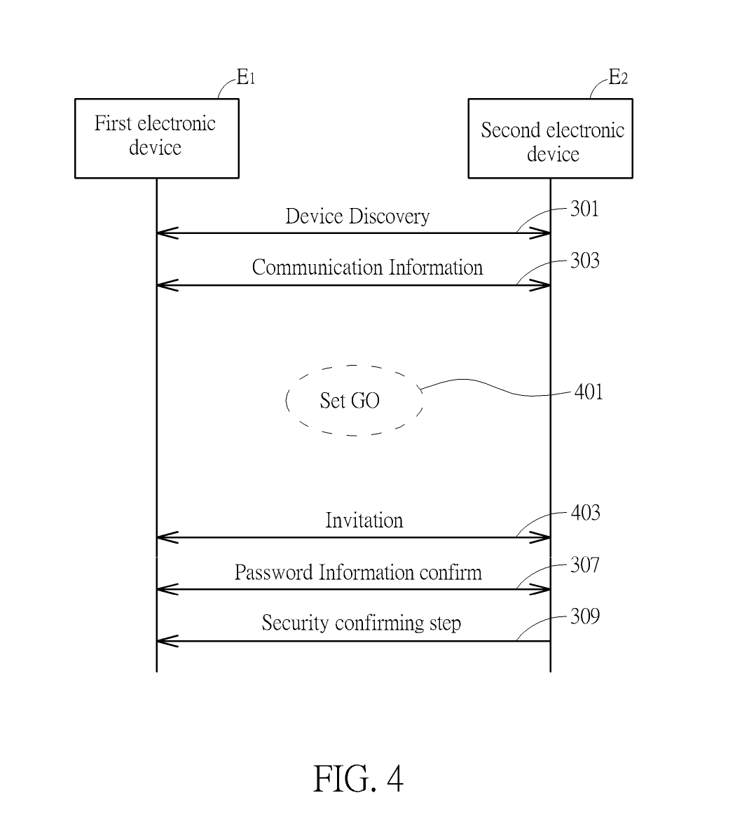

The communicating information exchanged in the step 303 can comprise other information. In another embodiment, the communicating information comprises ability and configuration method information (i.e. the information for the step 203 in FIG. 2). Also, in still another embodiment, the communicating information comprises group owner setting information for setting one of the first electronic device E₁ and the second electronic device E₂ as the GO. The setting of GO can depend on above-mentioned MAC address comparison or intent comparison. Or, the GO can be randomly set or be directly assigned. Additionally, in the embodiment of FIG. 3, a step 305 can be further comprised to set the GO, GC according to the group owner setting information in FIG. 3. In the embodiment of FIG. 4, only GO is set according to the group owner setting information in the step 401 in FIG. 3, and the wireless communicating method further comprises a step 403 for controlling the group owner to invite the second electronic device to join the group. For example, the first electronic device is set as GO in the step 401, and the first electronic device E₁ invites the second electronic device E₂ to join the group for which the first electronic device E₁ is GO.

In view of above-mentioned description, the concept of the present application can be summarized as:

Exchange the communication information before confirm the password information. The communication information comprise the password information (i.e. the information for the step 209 in FIG. 2), and at least one of the ability and configuration method information (i.e. the information for the step 203 in FIG. 2), the group owner setting information (i.e. the information for the step 205 in FIG. 2), the IP information (i.e. the information for the step 213 in FIG. 2), and the service information (i.e. the information for the step 215 in FIG. 2). If the information is not contained in the communication information, it can be transmitted via other steps.

All data for the communicating information can be comprised in a single packet, which will be described later. Also, the step 303 in FIG. 3 can exchange all data for the communicating information in one time exchanging.

More embodiments can be acquired based on the above-mentioned embodiment. For example, in one embodiment the wireless communicating method further comprises a security confirming step 309 that does not utilize the password information. For example, utilize a black list to block other electronic devices or utilize firmware encryption to protect the communication between the first electronic device and the second electronic device. In another embodiment, the wireless communicating method can further comprise the step of determining if a packet with specific content exists, if yes, performing the steps 303 and 307 in FIG. 3 (i.e. performing wireless communicating method according to the present application), if not, performing at least the steps 209-215 in FIG. 2 (i.e. performing a related art wireless communicating method).

Additionally, in one embodiment the direct communication and the step 303 both follow the same communication standard. For example, the direct communication and the step 303 all follow the WiFi standard. Additionally, in another embodiment the direct communication and the step 303 follow different communication standards. For example the direct communication follows the WiFi standard (in-band) but the step 303 follows the NFC standard (out-of-band).

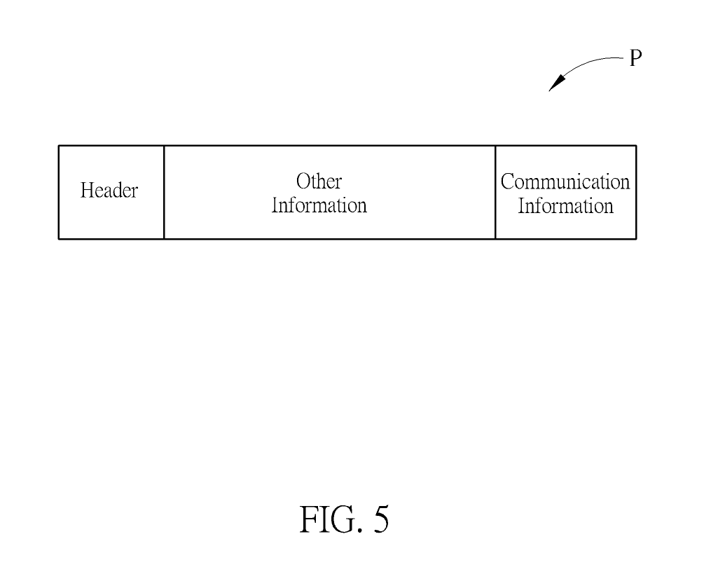

FIG. 5 is a schematic diagram illustrating a packet comprising the communicating information in FIG. 3 and FIG. 4. As shown in FIG. 5, the packet P comprises the header, other information (ex. the information necessary for the wireless connection other than the information described in FIG. 3 and FIG. 4) and communication information. In this embodiment, the “communicating information” follows the “other information”. However, the packet can be arranged such that the “other information” follows the “communicating information”.

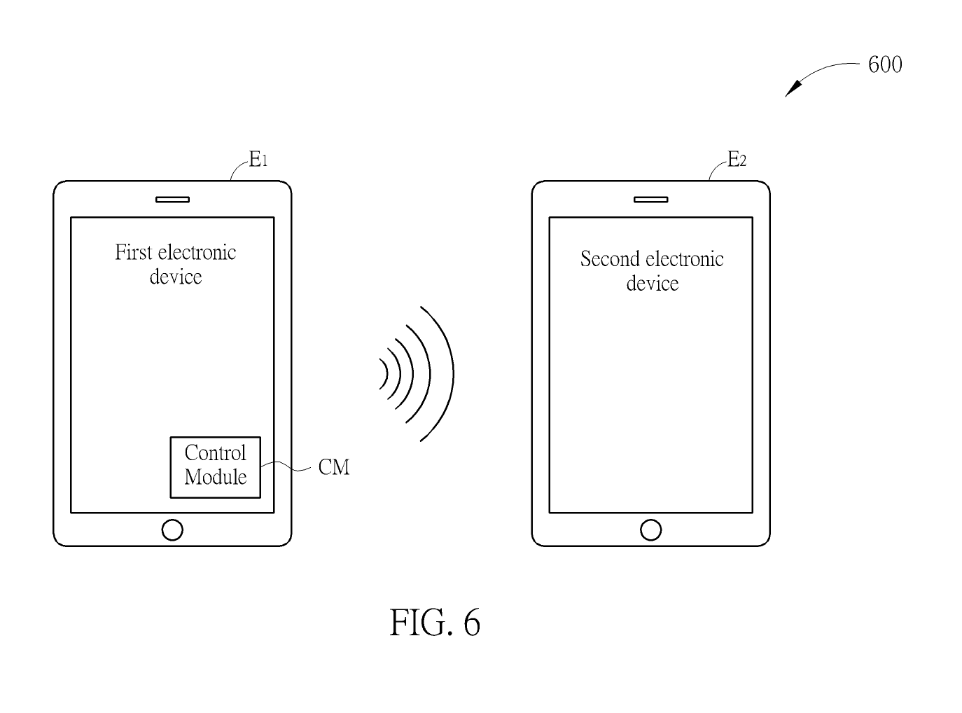

FIG. 6 is a schematic diagram illustrating an electronic system utilizing the wireless communicating methods in FIG. 3 and FIG. 4. As shown in FIG. 6, the electronic system 600 comprises a first electronic device E₁, a second electronic device E₂, and a control module CM. The control module CM is arranged to build direct communication between the first electronic device E₁ and the second electronic device E₂. The control module CM controls the first electronic device E₁ and the second electronic device E₂ to exchange communicating information of each other (i.e. the step 303 in FIG. 3). Additionally, after the communicating information is exchanged, the control module CM confirms the first password information (i.e. the step 307 in FIG. 3).

The control module CM can perform other embodiments as well, but is omitted here for brevity. The control module CM can be provided inside the first electronic device E₁ or the second electronic device E₂. Alternatively, the control module CM can be provided outside the first electronic device E₁ and the second electronic device E₂.

In view of above-mentioned embodiments, the necessary time for building a direct communication between two electronic devices can be decreased via reducing the number of information exchanging steps. Also, transmitting all communication information via a single packet or one time exchanging can further reduce the necessary time for building the direct communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communicating method, for building direct communication between a first electronic device and a second electronic device, comprising:
(a) controlling the first electronic device and the second electronic device to exchange communicating information of each other, wherein the communicating information comprises first password information, and comprises at least one of first IP information and first service information; and
(b) after the step (a), confirming the first password information exchange.

2. The wireless communicating method of claim 1, wherein the communicating information further comprises ability and configuration method information.

3. The wireless communicating method of claim 1, wherein the communicating information further comprises group owner setting information.

4. The wireless communicating method of claim 3, wherein the group owner setting information sets the first electronic device as the group owner, where the wireless communicating method further comprises:
(c) controlling the group owner to invite the second electronic device to join a group for which the first electronic device is the group owner.

5. The wireless communicating method of claim 4, wherein the step (c) is performed before the step (b).

6. The wireless communicating method of claim 1, wherein all data for the communicating information are all comprised in a single packet.

7. The wireless communicating method of claim 1, wherein the step (a) exchanges all data for the communicating information in one time exchanging.

8. The wireless communicating method of claim 1, further comprising a security confirming step that does not utilize the first password information.

9. The wireless communicating method of claim 1, wherein the direct communication follows a Wi-Fi direct standard.

10. The wireless communicating method of claim 1, further comprising:
(c) controlling the first electronic device and the second electronic device to exchange second password information;
(d) after the step (c), confirming the second password information;
(e) controlling the first electronic device and the second electronic device to exchange second IP information;
(f) controlling the first electronic device and the second electronic device to exchange second service information; and
(g) determining if a packet with specific content exists, if yes, performing the steps (c), (d), and at least one of the step (e) and the step (f), if not, performing the steps (a) and (b).

11. The wireless communicating method of claim 1, wherein the direct communication and the step (a) both follows a first communication standard.

12. The wireless communicating method of claim 1, wherein the direct communication follows a first communication standard but the step (a) follows a second communication standard.

13. An electronic system, comprising:
a first electronic device;
a second electronic device; and
a control module, for building direct communication between the first electronic device and the second electronic device;
wherein the control module controls the first electronic device and the second electronic device to exchange communicating information of each other, where the communicating information comprises first password information, and comprises at least one of first IP information and first service information;
after the communicating information is exchanged, the control module confirms the first password information.

14. The electronic apparatus of claim 13, wherein the communicating information further comprises ability and configuration method information.

15. The electronic apparatus of claim 13, wherein the communicating information further comprises group owner setting information.

16. The electronic apparatus of claim 15, wherein the control module utilizes the group owner setting information to set the first electronic device as the group owner, and invites the second electronic device to join a group for which the first electronic device is the group owner.

17. The electronic apparatus of claim 16, wherein the control invites the second electronic device to join the group after confirms the first password information.

18. The electronic apparatus of claim 13, wherein all data for the communicating information are all comprised in a single packet.

19. The electronic apparatus of claim 13, wherein the data for the communicating information is exchanged in one time exchanging.

20. The electronic apparatus of claim 13, wherein the control module further performs a security confirming step that does not utilize the first password information.

21. The electronic apparatus of claim 13, wherein the direct communication follows a Wi-Fi direct standard.

22. The electronic apparatus of claim 13, wherein the control module determines if a packet with specific content exists, if yes, control the first electronic device and the second electronic device to exchange communicating information of each other, and confirms the first password information after the communicating information is exchanged, if not, the control module performs the following steps:
controlling the first electronic device and the second electronic device to exchange second password information;
after the second password is exchanged, confirming the second password information;
controlling the first electronic device and the second electronic device to exchange second IP information;
controlling the first electronic device and the second electronic device to exchange second service information.

23. The electronic apparatus of claim 13, wherein the direct communication and the exchanging of the communicating information both follows a first communication standard.

24. The electronic apparatus of claim 13, wherein the direct communication follows a first communication standard but the exchanging of the communicating information follows a second communication standard.
